(19) United States
(12) Patent Application Publication
(10) Pub. No.: US 2024/0218223 A1
(43) Pub. Date: Jul. 4, 2024

(54) Adhesive, waterproofing and sealing glue, made from natural components, and the process for obtaining it

(71) Applicants: Ana Maria Aramburo, Mendoza (AR); Emiliana de Rosas, Mendoza (AR)

(72) Inventors: Ana Maria Aramburo, Mendoza (AR); Emiliana de Rosas, Mendoza (AR)

(21) Appl. No.: 18/149,176

(22) Filed: Jan. 3, 2023

(51) Int. Cl. C09J 189/04; C09J 11/04; C09J 101/02

(52) U.S. Cl. CPC C09J 189/04; C09J 11/04; C09J 101/02; C09J 2301/408; C09J 2401/006

(57) ABSTRACT

An adhesive, waterproofing, and sealing glue, with natural components, and the process to obtain it, based on the use of whey residues from the cheese industry and the pruning residue of Opuntia ficus-indica, a species with low water consumption, to which acetic acid, corn starch, sucrose, sodium bicarbonate, and traces of calcium silicate and boric salts are added. It is obtained through the process disclosed, natural glue that cements with sufficient adhesive and filling power, with proven mechanical strength, good texture and waterproofing finish, and with adequate micro-porosity for the breathability of the product. This glue is particularly useful for the construction industry, in the manufacture of laminated panels from cellulosic components, whether they are multi-laminated panels or those made from particle conglomerates.

### FIELD OF THE INVENTION

The present invention is related to an adhesive, waterproofing and sealing glue, of natural components, and the process for obtaining it. The advantages of these ecological, natural and biodegradable products are set out below, accompanied by a production scheme for a better understanding of the development, which is disclosed without such descriptions and figures being considered as limiting the invention but as an aid to its study, understanding and application.

### PREVIOUS ART

In the previous art, synthetic adhesives are known as those that are not found in nature and—in general—are the product of chemical synthesis, their main characteristic and common feature of synthetic adhesives is that they are all based on polymers. They are arguably the most widely used in various processes and sectors because of their practicality, mechanical and physicochemical properties. Even today, with greater environmental awareness, they are still the best positioned in the market compared to adhesives of natural origin.

There are various ways of classifying these adhesives, which can also be used to compare with natural adhesives and, in particular, with the adhesive which is the subject of the present invention, as follows: according to the number of components, they are classified into mono-components (a single reactive component), e.g. polyurethane adhesives, cyano acrylates, moisture-curing silicones, and modified silanes; components (two components to be mixed to facilitate the solidification or curing process), e.g. two-component polyurethane adhesives, acrylates, two-component epoxies, etc; according to the structure of the cured adhesive, and the polymeric nature of the adhesive, they are classified into thermoplastics, elastomers and thermosets; according to the type of curing (drying) of the adhesive into physically cured adhesives (e.g., contact cements and adhesive cements) and physically cured adhesives (e.g., contact cements and adhesive cements), contact cements and pressure sensitive adhesives) or chemically cured (e.g. polyurethanes, epoxies, acrylates); by their mechanical properties, they are divided into elastic adhesives (those with high elasticity before fracture), e.g. silicone, modified silanes, or single component and moisture curing polyurethanes; or rigid adhesives, which have high impact strength but are not elastic (e.g. epoxy, anaerobic, heat-curing structural polyurethanes, among others); finally, they are also classified by their state of aggregation.

Another way of classifying adhesives is that which refers to the type of surface for which they are intended; there are synthetic adhesives for metal surfaces, wood, cardboard and paper, plastics, ceramics, leather, etc.

They use organic solvents or mixtures of them (aliphatic and aromatic hydrocarbons, chlorinated hydrocarbons, ketones, esters and alcohols) which in solution are a powerful chemical pollutant in industrial hygiene and the environment due to the appearance of non-degradable contaminants, some of which are highly toxic.

The synthetic polymers used as base resin in the manufacture of these adhesives are scarce. However, there is a great diversity of resins that originate from copolymerization and alloys between them, which emit a great variety of intermediate degradation products. Some of these by-products cause risks by inhalation, affecting the respiratory tract, eyes and mucous membranes; or risks by contact, since many of these resins are allergens and skin sensitizers.

In addition, the application technique used in the use of these adhesives must be considered, as it may increase the risk of particle projection if they are sprayed. Finally, the flammability risks of the polymers present in each adhesive must be taken into account.

Of course, before synthetic adhesives were manufactured, there were already natural adhesives, which are those that are produced or extracted from the natural resources of our planet, resources such as plants or animals, starch, casein glues or natural rubber are examples of natural adhesives.

These adhesives were the first glues to be discovered and used in the long and complex history and evolution of adhesives.

In the development of natural adhesives, the components, the type of drying, the final state after curing or drying, the resulting mechanical properties, and the forms of presentation of the adhesive are also considered.

In the present invention, it has been possible to simplify the process of obtaining a glue suitable for the industry, obtained from natural ingredients, which could be classified according to the items previously mentioned as: natural adhesive, multi-component, with mechanical properties of gluing and sealing with polished finish, with waterproofing finish, and that can be presented with greater or lesser fluidity depending on the task to be performed with said glue.

The glue presented is recommended for cellulosic components, paper, cardboard and fabric, among others.

### OBJECTS OF THE INVENTION

One of the objects of this invention is to have a glue of natural origin, from totally organic components; and easy to obtain.

Another object of this invention is the use of discarded raw materials from other manufacturing processes on products of natural origin such as the dairy industry.

It is also an object of the invention, the recovery of waste from pruning of species with low water consumption.

Another object of the proposed invention is its total biodegradability, contributing to environmental safety and reducing the carbon footprint.

It is also an object of the invention that it is non-toxic to those who operate with it in any task, be it industrial manufacturing or domestic work.

It is another essential object of this invention to be suitable for cementing cellulosic components such as paper, cardboard and fabrics.

It is also an object of the invention its ability to seal and facilitate the finishing of that which its adhesion facilitates.

And likewise, an object of the invention is its suitability to be applied as a waterproofing lacquer for surfaces and finishes in different materials.

It is therefore an object of the invention its suitability to be used in the manufacture of lamellar materials for construction from cellulosic components such as multi-laminated panels or those made by particle conglomerates.

It is another object of this invention to have sufficient ductility for the various uses mentioned above in different modes of presentation: liquid and viscous.

Another object of this invention is that it is easy to use.

Finally, it is an object of this invention to reduce manufacturing costs in laminar materials for construction.

### SUMMARY OF THE INVENTION

The invention for which protection is sought consists of an adhesive, waterproofing and sealing glue of natural components, and the process for obtaining it.

The proposed glue is based on the use of residues from the dairy industry and pruning of species with low water consumption, together with other natural substances added.

Specific use is made of whey residues from the cheese industry, corn starch, sucrose, Nopal (Opuntia ficus-indica) pruning waste, traces of calcium silicate and boric salts.

Natural glue is obtained through the process disclosed, that cements with sufficient adhesive and filling power, with proven mechanical strength, good texture and finish, and with adequate micro-porosity for the breathability of the product.

### DETAILED DESCRIPTION OF THE INVENTION

Preferable percentages are established and proportions are respected, mentioning the components in the same order of appearance within the glue manufacturing process:

Whey ranges between 65 and 80%, preferably 70% (in grams): The composition of a whey varies depending on the origin of the milk and the type of cheese made, in general the approximate content is 93.1% water, 4.9% lactose, 0.9% crude protein, 0.6% minerals, 0.3% fat, 0.2% lactic acid and water-soluble vitamins; but, for the purposes of this invention all whey is viable to use.

Acetic acid from 4% to 8%, preferably 5% (ml): This liquid allows the curdling of milk and the separation of casein by lowering the pH.

Sodium bicarbonate 2% to 4%, preferably 3% (grams): Powder used for neutralization of the acid added to the mixture.

Starch between 5% and 10%, 7% (grams) being preferable: Powder formed by 25% Amylase and 75% Amylopectin, Powder used to give body to the mixture due to its binding effect.

Sucrose between 0.5% and 2%, preferably 1% (gram): Powder use, helps regulate gelling and works as a natural preservative.

Boron salts 0.5% to 2%, being preferable 1% (gram): Use in powder form, to avoid the development of microorganisms.

Nopal cactus cladodes (Opuntia ficus-indica) from 9% to 15%, being preferable for the realization as presented 11% (ml): This liquid gives the resulting product fireproofing and waterproofing properties.

Calcium silicate between 1% and 4%, 2% being preferable (grams): Liquid that improves drying and adhesion properties.

### Process, Components and Results

The components considered for the proposed invention have been considered in their preferable percentages and are mainly, milk proteins (caseins and amino acids) from whey discarded in the manufacture of cheese (70% of the mixture); acetic or ethanoic acid (C₂H₄O₂) (5% of the mixture); starch (one-quarter amylase+three-quarters amylopectin) (7% of the mixture); sodium bicarbonate (NaHCO₃) (3% of the mixture); sucrose (C₁₂H₂₂O₁₁) (1% of the mixture); Nopal (Opuntia ficus-indica) cladodes normally discarded from pruning, processed (11% of the mixture); and Boron (1% of the mixture) and Calcium salts (2% of the mixture).

The process for its preparation, after obtaining the whey discarded in the manufacture of cheese, begins with a first step in which the whey must be neutralized in a mixing hopper by adding acetic acid and sodium bicarbonate, and mixing the products at room temperature for a few minutes to verify the uniformity of the mixture, after which the mixture is left to stand for 3 to 10 minutes, normally for 5 minutes; once the neutralized whey foam is formed, in a second step the powdered starch, sucrose and boric salts are added and all the ingredients are mixed again until a homogeneous and lump-free paste is obtained; in a third step, the mixed Opuntia ficus-indica residue is added, which has been previously soaked in hot water (at 80°) for 10 to 30 minutes, at least 15 minutes, and the product is mixed again until uniformity is achieved; the fourth step corresponds to the careful packaging of the glue in different types of containers, sizes and conditions, according to the final destination of the glue.

Considering the total of the product to be prepared, the products of more weight and main components in the mixture for this glue are the lactic serum (70%), and the previously mixed residues of Opuntia ficus-indica (11%), then the starch (7%), and the remaining 12% corresponds to the sum of the rest of the components (bicarbonate, sucrose, boric and calcium salts).

Each of the ingredients brings different qualities that, in combination, as mentioned above, will provide the result that is intended: glue with ductility, viscosity, anti-fungal and microbiological preservation factor, with adequate binding and good drying process.

The resulting glue has optimum cementing properties for cellulosic components, and is able to transmit its waterproof and fireproof properties to the product to be glued or bonded with this adhesive.

As for the finish of the final product, it can vary according to the application for which it is intended, being more or less liquid or viscous: the key to this variation will be given by the percentages of its two main components, whey and Opuntia ficus. A more fluid result will be sought if it is intended to take advantage of its waterproofing function or with greater viscosity if its adhesive function is to be prioritized.

The viscosity varies depending on the proportions of opuntia, which provides liquid and gives fluidity, or the amount of calcium silicate, which increases the adhesion and drying capacity of the final product.

The final product should be correctly packaged, preferably in glass containers and covered to avoid decomposition in contact with the external air, in an environment that does not exceed 35° C.

For small household and office tasks and needs, the product will be distributed in small packages, while for industrial uses the product will be distributed in large vacuum-sealed packages.

This glue requires that it be conveniently shaken or mixed before use, because after a certain period of time (usually after 4 or 5 days without use) it may separate into phases, when shaken or stirred the glue will recover its uniformity.

Having described the nature of the product that motivates the present invention and the process to obtain it, the following is claimed as an exclusive right of the inventors:

1. An adhesive, waterproofing, and sealing glue made of natural components and obtained mainly from two organic components coming from raw materials discarded from other processes, the adhesive, waterproofing and sealing glue comprising:
a whey discarded from cheese manufacturing in a range between 65% and 80% of the mixture in grams;
a nopal (Opuntia ficus-indica) cladodes discarded from pruning and processed, in a range between 9% and 15% (ml) of the mixture;
acetic acid, from 4% to 8% (ml) of the mixture;
sodium bicarbonate between 2% and 4% (grams) of the mixture;
starch in the proportion between 5% and 10% (grams);
sucrose between 0.5% and 2% (grams);
boron salts between 0, 5% and 2% (grams); and
calcium silicate between 1% and 4% (grams),
wherein the adhesive, waterproofing, and sealing glue is a biodegradable product, without toxicity, with flame retardant properties and suitable for cementing, sealing, and finishing cellulosic components and construction materials.

2. The adhesive, waterproofing, and sealing glue, with natural components, according to claim 1, wherein the adhesive, waterproofing and sealing glue contributes to environmental safety and reduces the carbon footprint.

3. The adhesive glue, waterproofing, and sealing glues according to claim 1, wherein the boron salts prevent the formation of microorganisms and provide anti-fungal properties, obtaining a product that lacks toxicity for the operator and for the environment.

4. The adhesive, waterproofing, and sealing glue according to the claim 1, wherein the nopal (Opuntia ficus-indica) cladodes provides fireproofing and waterproofing properties that are transmitted to the products cemented and sealed with said adhesive.

5. The adhesive, waterproofing, and sealing glue according to the claim 1, wherein the sealing glue is use for cementing cellulosic components such as paper, cardboard, or fabrics.

6. The adhesive, waterproofing, and sealing glue according to claim 1, wherein the sealing glue is used to manufacture laminated materials with cellulosic components, whether manufactured as multi-laminated panels or as particle conglomerates, or chipboard.

7. The adhesive, waterproofing, and sealing glue according to claim 1, wherein the adhesive glue seals and facilitate surface finishing of the products to be adhered.

8. The adhesive, waterproofing, and sealing glue according to claim 7, wherein the sealing glue is use as a waterproofing lacquer for surfaces and final finishing of different materials.

9. The adhesive, waterproofing, and sealing glue according to claim 1, wherein the sealing glue has different degrees of fluidity or viscosity according to the applications for which it is intended by decreasing the proportions of nopal (Opuntia ficus-indica) cladodes to provide less fluidity and increasing the starch and the calcium silicate to add more binder effect and drying properties respectively.

10. A process for obtaining an adhesive, waterproofing, and sealing glue from natural components, the process comprising the steps of:
loading whey into a hopper;
adding acetic acid to the whey to separate water from casein and proteins;
adding to the mixture of the previous step bicarbonate to neutralize acidity;
mixing at room temperature leaving the mixture to stand for between 3 and 10 minutes until the neutralized whey foam stops forming;
adding to the mixture powdered starch, sucrose, and boric salts, and then mixing again until a homogeneous and lump-free paste is obtained;
adding a liquid resulting from processing a nopal (Opuntia ficus-indica) cladodes, which has been previously soaked in hot water (at 80°) for 10 to 30 minutes;
mixing again until obtaining a product having a uniform mixture;
optionally packaging of the product.
